(19) United States
(12) Patent Application Publication
(10) Pub. No.: US 2012/0250348 A1
(43) Pub. Date: Oct. 4, 2012

(54) BACKLIGHT UNIT, METHOD OF FABRICATING THE UNIT, AND DISPLAY APPARATUS INCLUDING THE UNIT

(76) Inventors: Rae-Young Kim, Seoul (KR); Taek-Sun Shin, Cheonan-si (KR); Seungin Baek, Seoul (KR); Jin Seo, Osan-si (KR)

(21) Appl. No.: 13/206,067

(22) Filed: Aug. 9, 2011

(30) Foreign Application Priority Data
Mar. 29, 2011 (KR) 10-2011-0028312

(51) Int. Cl. F21V 8/00; B29C 65/54; F21V 5/02

(52) U.S. Cl. 362/602; 362/606; 156/211

(57) ABSTRACT

A backlight unit includes a light guide plate configured to guide light and including at least one light incident surface for receiving light, and a light exit surface for directing the received light toward a display panel, a plurality of light sources configured to emit light toward the light incident surface, and an optical member disposed at a light exit surface of the light guide plate to direct light output from the light guide plate. The optical member may include at least one sheet, which may have a first portion positioned over the light exit surface of the light guide plate, and a second portion positioned over the light incident surface.

### CROSS-REFERENCE TO RELATED APPLICATIONS

This U.S. non-provisional patent application claims priority under 35 U.S.C. §119 to Korean Patent Application No. 10-2011-0028312, filed on Mar. 29, 2011, the entire contents of which are hereby incorporated by reference.

### BACKGROUND

The present disclosure herein relates generally to flat panel displays, and more particularly to a backlight unit of a flat panel display, the backlight unit capable of improving display quality, as well as a method of fabricating the backlight unit, and a display apparatus including the backlight unit.

Display apparatuses including display panels such as liquid crystal display (LCD) panels or electrophoretic display panels (EDPs) are not self-luminescent display apparatuses. Thus, such display apparatuses require backlight units to supply light to their respective display panels.

In general, such backlight units include light sources having a plurality of light emitting diodes (LEDs), and light guide plates configured to guide light emitted from the light sources to their respective display panels.

However, since the LEDs of the light sources are point light sources, when light is emitted from the LEDs to a light incident surface of the light guide plate, “hot spots” or bright spots may appear on the light incident surface of the light guide plate, reducing the image display quality of a display apparatus.

### SUMMARY

The present disclosure provides a backlight unit having improved display quality.

The present disclosure also provides a method of fabricating the backlight unit.

The present disclosure also provides a display apparatus including the backlight unit.

Embodiments of the inventive concept provide backlight units including a light guide plate configured to guide light and including at least one light incident surface for receiving light and a light exit surface for directing the received light toward a display panel, a plurality of light sources configured to emit light toward the light incident surface, and an optical member disposed at a light exit surface of the light guide plate to direct light output from the light guide plate. The optical member may include at least one sheet, which has a first portion positioned over the light exit surface of the light guide plate, as well as a second portion positioned over the light incident surface.

In some embodiments, the first portion may be a light guide plate cover part covering the light exit surface of the light guide plate, and the second portion may be a light diffusing part bent from at least one side of the light guide plate cover part and disposed between the light guide plate and the light sources.

In other embodiments, the backlight unit may further include an adhesive disposed between the light incident surface and the light diffusing part.

In still other embodiments, the at least one sheet may be a prism sheet, and the prism sheet may include a plurality of at least approximately parallel prism patterns extending in a direction from one side of the prism sheet to an opposite side of the prism sheet.

In further embodiments, the backlight unit may further include a diffusing sheet disposed between the light guide plate and the prism sheet.

In still further embodiments, the backlight unit may further include a protective sheet disposed on a light exiting surface of the prism sheet, so as to protect the prism sheet.

In yet further embodiments, the at least one sheet may be a diffusing sheet.

In other embodiments of the inventive concept, there are provided methods of fabricating a backlight unit, the methods including receiving a sheet, forming at least one bending line in the sheet, the bending line formed in a direction at least approximately parallel with a side of the sheet through a half cutting process, so as to divide the sheet into a light guide plate cover part and a light diffusing part, and disposing the light guide plate cover part on a light exit surface of a light guide plate and disposing the light diffusing part on a lateral surface of the light guide plate by bending the light diffusing part along the bending line.

In some embodiments, after the forming of the bending line, the method further may further include applying an adhesive to a surface of the light diffusing part for facing the lateral surface of the light guide plate.

In still other embodiments of the inventive concept, there are provided methods of fabricating a backlight unit, the methods including preparing a sheet including one of polymethylmethacrylate (PMMA) and polycarbonate (PC), disposing a mold on the sheet, wherein top and bottom sides of the mold are opened and a ridge-furrow shaped pattern is formed on a lateral surface of the mold, where the lateral surface extends between the top and bottom sides of the mold, performing a die-cutting process on the sheet using the mold so as to form a light guide plate including a light diffusing pattern on a light incident surface thereof, and disposing an optical member at a light exit surface of the light guide plate.

In even other embodiments of the inventive concept, there are provided display apparatuses including a backlight unit, and a display panel. The backlight unit includes a light guide plate configured to guide light and including at least one light incident surface for receiving light, and a light exit surface for directing the received light toward a display panel, a plurality of light sources configured to emit light toward the light incident surface, and an optical member disposed at a light exit surface of the light guide plate to direct light output from the light guide plate. The display panel may display images using light received from the light guide plate. The optical member may include at least one sheet, which may have a first portion positioned over the light exit surface of the light guide plate and a second portion positioned over the light incident surface.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is an exploded perspective view illustrating a display apparatus according to an embodiment of the inventive concept;

FIG. 2 is a perspective view illustrating a light guide plate and an optical member of a backlight unit of the display apparatus according to an embodiment of the inventive concept;

FIG. 3 is a sectional view taken along line I-I′ of FIG. 2;

FIG. 4 is a sectional view taken along line II-IP of FIG. 2;

FIGS. 5 through 7 are views for explaining a method of fabricating a backlight unit of a display apparatus according to an embodiment of the inventive concept; and

FIGS. 8 through 10 are views for explaining a method of fabricating a light guide plate of a backlight unit of a display apparatus according to another embodiment of the inventive concept.

### DETAILED DESCRIPTION OF THE EMBODIMENTS

Exemplary embodiments of the inventive concept will be described below in more detail with reference to the accompanying drawings. The inventive concept may, however, be embodied in different forms and should not be construed as limited to the embodiments set forth herein. Various modifications, equivalents, and substitutes may be provided within the scope and spirit of the inventive concept.

In the following descriptions of the drawings, like reference numerals refer to like elements. In addition, the dimensions of elements are exaggerated for clarity of illustration. It will be understood that although the terms first and second are used herein to describe various elements, these elements should not be limited by these terms. These terms are used only to discriminate one element from another element. For example, an element referred as a first element in one embodiment may be referred to as a second element in another embodiment, and an element referred to as a second element in one embodiment may be referred to as a first element so long as this naming does not obscure the scope of the inventive concept. The terms of a singular form may include plural forms unless referred to the contrary.

The meaning of “include,” “comprise,” “including,” or “comprising,” specifies a property, a region, a fixed number, a step, a process, an element, and/or a component but does not exclude other properties, regions, fixed numbers, steps, processes, elements and/or components. It will also be understood that when an element such as a layer, a film, a region, and a plate is referred to as being ‘on’ another element, it can be directly on the other element, or one or more intervening elements may also be present. Further, it will be understood that when an element such as a layer, a film, a region, and a plate is referred to as being ‘under’ another element, it can be directly under, and one or more intervening elements may also be present. In addition, it will also be understood that when an element is referred to as being ‘between’ two elements, it can be the only element between the two elements, or one or more intervening elements may also be present.

Hereinafter, exemplary embodiments of the inventive concept will be described in detail with reference to the accompanying drawings.

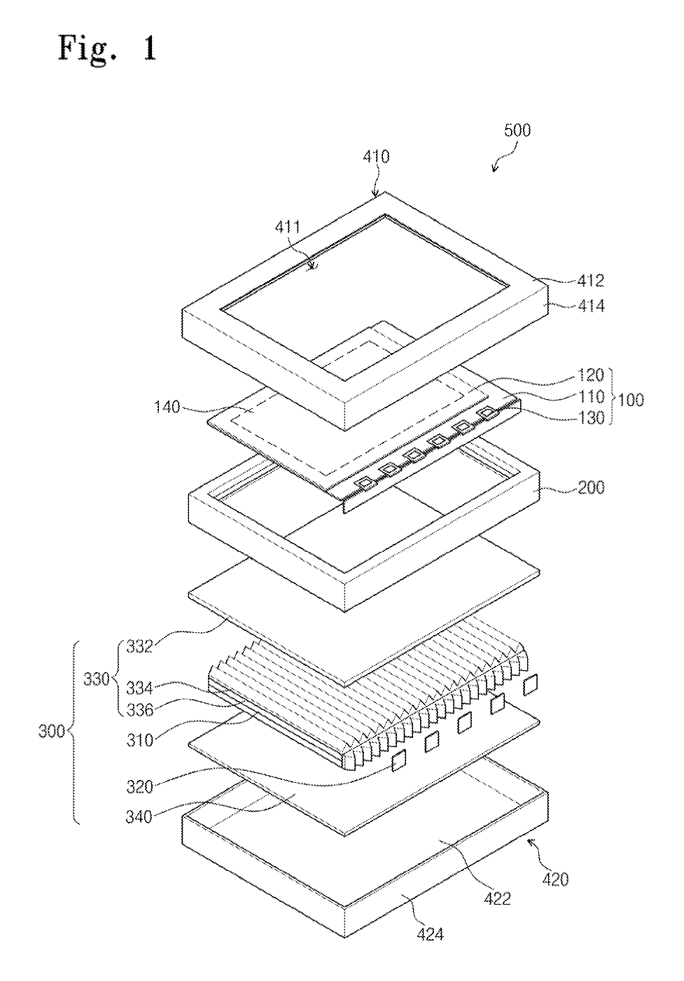

FIG. 1 is an exploded perspective view illustrating a display apparatus 500 according to an embodiment of the inventive concept.

Referring to FIG. 1, the display apparatus 500 of the current embodiment includes a display panel 100, a backlight unit 300, an upper cover 410, and a lower cover 420.

The display panel 100 may be one of various display panels, such as a liquid crystal display (LCD) panel or an electrophoretic display panel (EDP). The current embodiment will be explained for an exemplary case where the display panel 100 is an LCD panel.

The display panel 100 is shaped generally like a rectangular plate having a long side and a short side. The display panel 100 includes a display region 140 to display images. The display panel 100 further includes an array substrate 110, an opposite substrate 120 facing the array substrate 110, and a liquid crystal layer (not shown) disposed between the array substrate 110 and the opposite substrate 120.

In an embodiment of the inventive concept, the array substrate 110 may include a plurality of pixels (not shown) arranged in matrix format. Each of the pixels includes a gate line (not shown) extending generally in a first direction parallel with, for example, an edge of the array substrate 110, a data line (not shown) insulated from the gate line and extending across the gate line generally in a second direction perpendicular to the first direction, and a pixel electrode. The gate line and the data line are electrically connected to the pixel, and a thin film transistor (not shown) corresponding to the pixel is electrically connected to the pixel. The thin film transistor is used as a switching device for a driving signal addressed to the pixel.

Driver integrated circuits (ICs) 130 may be provided at a side of the array substrate 110. The driver ICs 130 receive various signals such as control signals, and output driving signals to the thin film transistors in response to the control signals so as to drive the display panel 100.

The opposite substrate 120 may include an RGB color filter (not shown) on a surface thereof to express colors by using light coming from the backlight unit 300, and common electrodes (not shown) disposed on the RGB color filter at positions facing the pixel electrodes. The RGB color filter may be formed through a thin film forming process. Although the RGB color filter is disposed on the opposite substrate 120 in the current embodiment, the inventive concept is not limited thereto. For example, the RGB color filter may instead be disposed on the array substrate 110.

The alignment of molecules of the liquid crystal layer can be varied according to a voltage applied between the pixel electrodes and the common electrodes. Accordingly, the transmittance of light coming from the backlight unit 300 can be varied in the liquid crystal layer, and thus images can be displayed on the display panel 100.

A mold frame 200 is disposed along the edges of the display panel 100 to support the bottom side of the display panel 100. The mold frame 200 has an approximately rectangular shape. In FIG. 1, only one mold frame 200 is illustrated. However, if necessary, an assembly of a plurality of mold frames may be used. In some cases, the mold frame 200 may be omitted.

The backlight unit 300 is disposed under the display panel 100. The backlight unit 300 includes a light guide plate 310, a plurality of light sources 320 configured to emit light toward the light guide plate 310, an optical member 330, and a reflective sheet 340.

The light guide plate 310 is disposed under the display panel 100 to guide light emitted from the light sources 320 toward the display panel 100. The light guide plate 310 overlaps at least the display region 140 of the display panel 100.

The light guide plate 310 may be formed in various shapes. For example, the light guide plate 310 may include a generally rectangular top surface, a bottom surface opposite to the top surface, and four lateral surfaces connecting the top and bottom surfaces. At least one of the four lateral surfaces may be a light incident surface along which the light sources 320 are arranged, and the top surface may be a light exit surface through which light from the light sources 320 is output toward the display panel 100.

The light sources 320 may include light emitting diodes (LEDs). The light sources 320 are arranged in a manner such that the light sources 320 can emit light toward at least one of the four lateral surfaces of the light guide plate 310, i.e. the light incident surface. Light emitted from the light sources 320 to the light guide plate 310 is guided by the light guide plate 310 to the display panel 100.

The optical member 330 is disposed between the light guide plate 310 and the display panel 100. The optical member 330 is used to control light emitted from the light sources 320 and output through the light guide plate 310. The optical member 330 includes one or more sheets. One of the sheets is bent in a manner such that a portion of the sheet is disposed between the light guide plate 310 and the light sources 320.

In the current embodiment, the optical member 330 includes a diffusing sheet 336, a prism sheet 334, and a protective sheet 332. However, the inventive concept is not limited thereto. For example, at least one of the diffusing sheet 336, the prism sheet 334, and the protective sheet 332 may be provided in plurality or may be omitted entirely. Particularly, two prism sheets 334 may be used.

The reflective sheet 340 is disposed under the light guide plate 310. Leakage light not guided toward the display panel 100 is reflected by the reflective sheet 340 toward the display panel 100. The reflective sheet 340 includes a light reflective material. The reflective sheet 340 is disposed on the lower cover 420 to reflect light coming from the light sources 320. Thus, owning to the reflective sheet 340, more light can be provided to the display panel 100.

The upper cover 410 is disposed on the topside of the display panel 100. The upper cover 410 has a shape corresponding to the shape of the display panel 100. The upper cover 410 includes: a display window 411 to expose the display region 140 of the display panel 100; an upper surface 412 supporting and/or protecting front edges of the display panel 100; and lateral surfaces 414 bent from the upper surface 412 and extending toward the lower cover 420. Since the display panel 100 has a rectangular plate shape, the upper cover 410 may include four lateral surfaces 414. The upper cover 410 is coupled to the lower cover 420 to support the front edges of the display panel 100.

The lower cover 420 is disposed under the backlight unit 300. The lower cover 420 includes: a bottom surface 422 having a shape corresponding to the shapes of the display panel 100 and the backlight unit 300; and lateral surfaces 424 bent upward from the bottom surface 422. Since the display panel 100 and the backlight unit 300 have rectangular shapes, the lower cover 420 may include four lateral surfaces 424. The display panel 100 and the backlight unit 300 are accommodated within a space formed by the bottom surface 422 and the lateral surfaces 424 of the lower cover 420. The lower cover 420 is coupled to the upper cover 410 so that the display panel 100 and the backlight unit 300 can be accommodated and supported in the lower cover 420 and the upper cover 410.

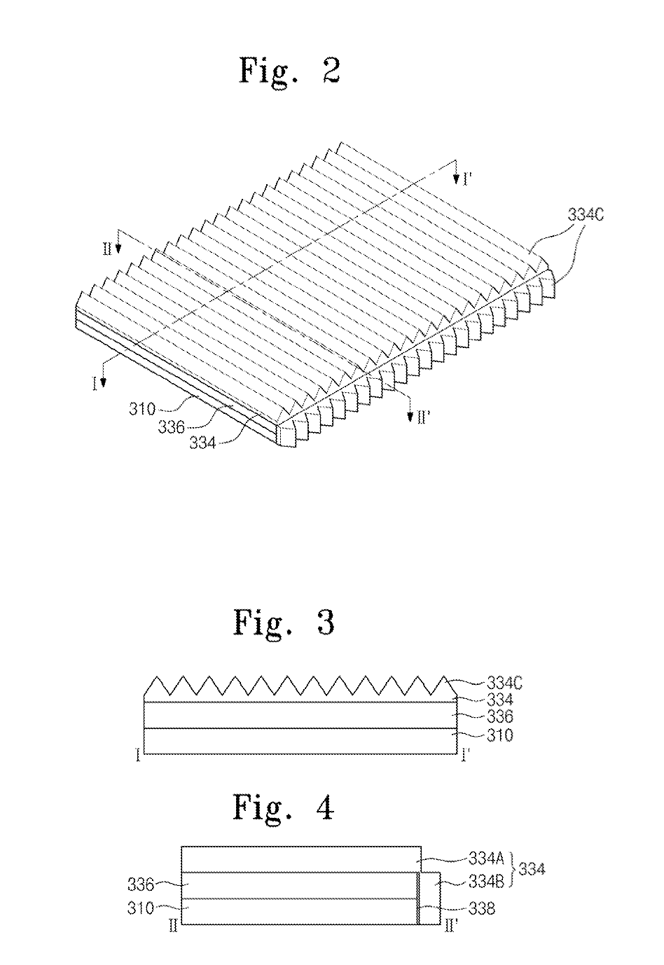

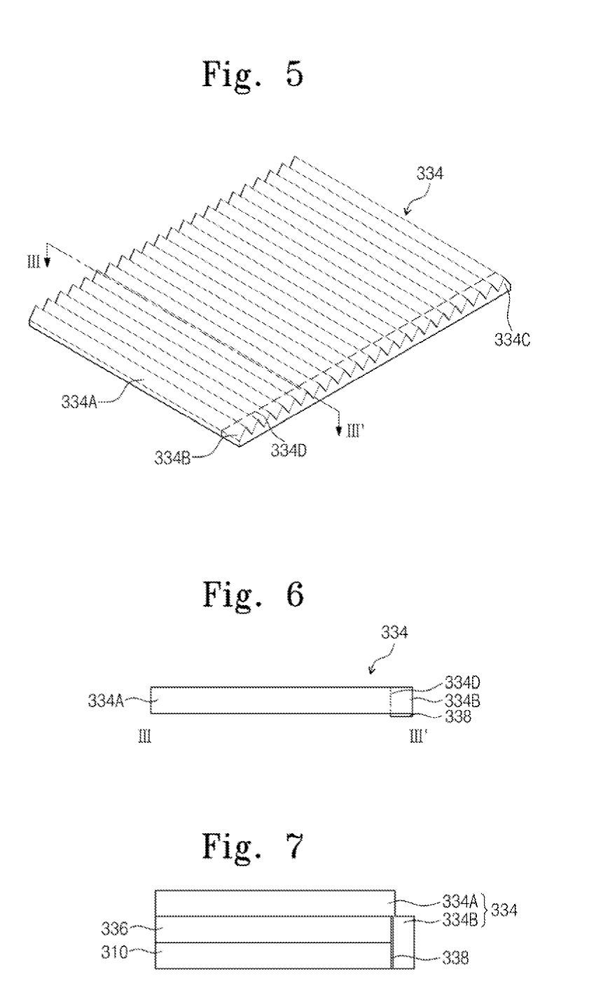

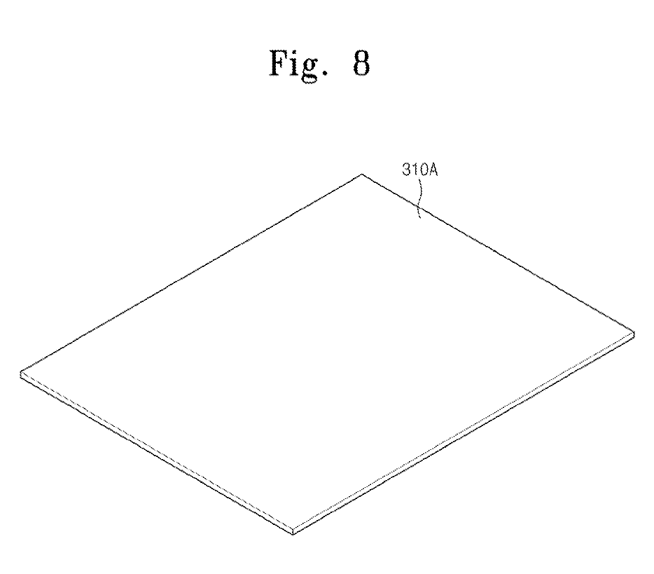

FIG. 2 is a perspective view illustrating the light guide plate 310, the diffusing sheet 336, and the prism sheet 334 of the backlight unit 300 of the display apparatus according to an embodiment of the inventive concept; FIG. 3 is a sectional view taken along line I-I′ of FIG. 2; and FIG. 4 is a sectional view taken along line II-IP of FIG. 2.

Referring to FIGS. 2 through 4, the diffusing sheet 336 and the prism sheet 334 may be disposed on the topside of the light guide plate 310.

The light guide plate 310 may have various shapes. In the current embodiment, the light guide plate 310 includes a generally rectangular top surface, a bottom surface opposite to the top surface, and four lateral or side surfaces.

The optical member 330 (including at least one sheet) may be disposed at the light exit surface of the light guide plate 310. For example, the diffusing sheet 336, the prism sheet 334, and the protective sheet 332 of the optical member 330 may be sequentially disposed along an optical path of light discharged from the light guide plate 310.

One of the diffusing sheet 336 and the prism sheet 334 may be bent so that a bent portion can be disposed between the light guide plate 310 and the light sources 320.

In detail, one of the diffusing sheet 336 and the prism sheet 334, for example the prism sheet 334, may include a light guide plate cover part 334A covering the light exit surface of the light guide plate 310, and a light diffusing part 334B bent from at least one side of the light guide plate cover part 334A and disposed between the light guide plate 310 and the light sources 320.

The diffusing sheet 336 has a shape corresponding to the top surface of the light guide plate 310. For example, the diffusing sheet 336 may have a generally rectangular shape. The diffusing sheet 336 is disposed on the light exit surface of the light guide plate 310 to diffuse light output from the light guide plate 310. Therefore, light having more uniform brightness can be provided from the diffusing sheet 336 to the display panel 100.

The prism sheet 334 may be disposed on the diffusing sheet 336 along an optical path of light discharged from the light guide plate 310. The prism sheet 334 may have a generally rectangular shape. The prism sheet 334 may include a plurality of prism patterns 334C on a surface facing the display panel 100. The prism patterns 334C extend from a side of the prism sheet 334 to an opposing and parallel side of the prism sheet 334. The prism patterns 334C extend generally parallel to each other.

Light diffused by the diffusing sheet 336 is condensed in, or directed along, a direction substantially perpendicular to the display panel 100 by the prism patterns 334C. That is, in the aggregate, the prism patterns 334C tend to direct exiting light toward the display panel 100, so that more light reaches the display panel 100 from the light sources 320. Therefore, most of light that has passed through the light guide plate cover part 334A is incident onto the display panel 100 in a direction substantially perpendicular to the display panel 100.

An adhesive 338 may be applied to a surface of the light diffusing part 334B facing the light guide plate 310, so that the light diffusing part 334B can be attached to a lateral surface of the light guide plate 310. The adhesive 338 may be transparent so as not to significantly reduce the brightness of light emitted from the light sources 320.

Light emitted from the light sources 320 to the light diffusing part 334B is diffused by the prism patterns 334C of the light diffusing part 334B, and the diffused light enters the light guide plate 310. More specifically, the prism patterns 334C generally condense exiting light, but conversely tend to diffuse entering light. Thus, unlike the prism patterns 334C of the light guide plate cover part 334A that condense light, the prism patterns 334C of the light diffusing part 334B diffuse light. Therefore, although the light sources 320 include LEDs, hot spots may not appear at the light incident surface of the light guide plate 310, or their appearance may be reduced.

The protective sheet 332 (not shown in FIGS. 2 to 4) may be disposed at a light exit surface of the light guide plate cover part 334A to protect the prism sheet 334, for example, from external impacts.

In the current embodiment, the prism sheet 334 is bent, and the bent portion of the prism sheet 334 is disposed between the light guide plate 310 and the light sources 320. However, the inventive concept is not limited thereto. For example, the diffusing sheet 336 may instead be bent, and the bent portion of the diffusing sheet 336 may be disposed between the light guide plate 310 and the light sources 320. That is, the diffusing sheet 336 may include a light guide plate cover part covering the light exit surface of the light guide plate 310, and a light diffusing part bent from the light guide plate cover part and disposed between the light guide plate 310 and the light sources 320. In this case, the adhesive 338 may be applied to a surface of the light diffusing part of the diffusing sheet 336 that faces the light guide plate 310.

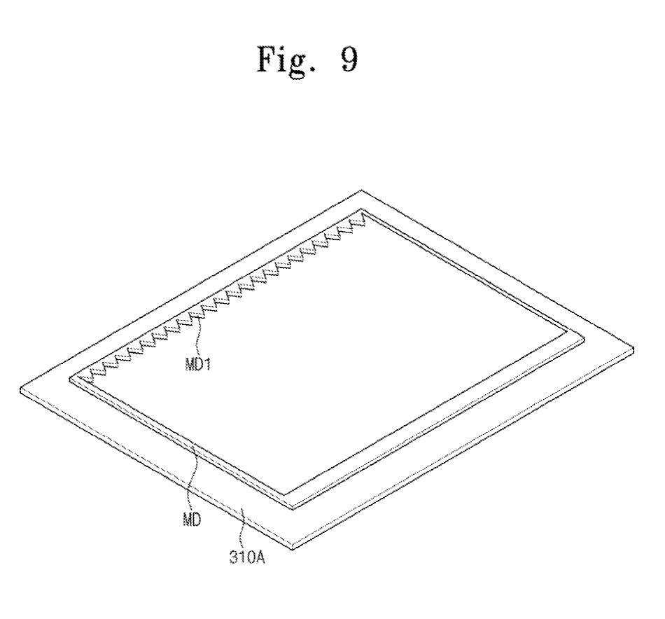

FIGS. 5 through 7 are views for explaining a method of fabricating a backlight unit of a display apparatus according to an embodiment of the inventive concept.

Referring to FIG. 5, a generally rectangular prism sheet 334 is prepared. The prism sheet 334 includes a plurality of generally parallel prism patterns 334C each of which extends from one of four sides of the prism sheet 334 to an opposing and generally parallel side of the prism sheet 334.

Thereafter, the prism sheet 334 is half cut in a direction perpendicular to the prism patterns 334C, to form at least one bending line 334D that is perpendicular to the prism patterns 334C. Then, the prism sheet 334 is divided by the bending line 334D into a light guide plate cover part 334A and a light diffusing part 334B. Here, the term “half cut” refers to any cutting operation, regardless of the actual depth of the cut, or how this cut is made. Thus, the cutting operations herein need not necessarily cut to exactly one half the depth of the prism sheet 334, but instead can form a bending line of any suitable depth, by any suitable manner.

Referring to FIG. 6, after the prism sheet 334 is half cut, an adhesive 338 is applied to a surface of the light diffusing part 334B opposite to the prism patterns 334C. The adhesive 338 may be formed of a transparent material, so that light can pass through the adhesive 338.

Referring to FIG. 7, after the adhesive 338 is applied to the light diffusing part 334B of the prism sheet 334, the light guide plate cover part 334A of the prism sheet 334 is disposed on a light exit surface of a light guide plate 310. A diffusing sheet 336 may have been previously disposed on the light exit surface of the light guide plate 310 before the light guide plate cover part 334A of the prism sheet 334 is disposed on the light exit surface of the light guide plate 310. That is, a diffusing sheet 336 is first affixed to the light exit surface of light guide plate 310, and the prism sheet 334 is then affixed to the diffusing sheet 336 so as to also overlie the light exit surface of the light guide plate 310.

Then, the light diffusing part 334B is bent along the bending line 334D, and the surface of the light diffusing part 334B to which the adhesive 338 is applied is attached to a lateral surface of the light guide plate 310 as well as a lateral surface of diffusing sheet 336. The light diffusing part 334B is then attached to both the light guide plate 310 and diffusing sheet 336.

Thereafter, a plurality of light sources 320 are disposed at predetermined positions so that the light sources 320 can emit light toward the prism patterns 334C of the prism sheet 334.

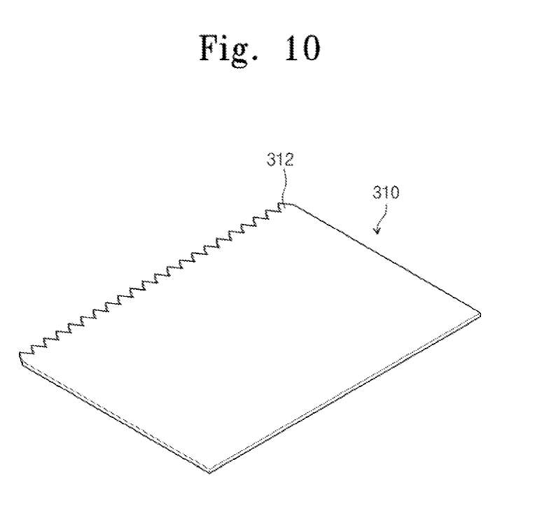

FIGS. 8 through 10 are views for explaining a method of fabricating a light guide plate of a backlight unit of a display apparatus according to another embodiment of the inventive concept.

Referring to FIG. 8, a light guide plate sheet 310A is prepared. The light guide plate sheet 310A may include one of polymethylmethacrylate (PMMA) and polycarbonate (PC).

Referring to FIG. 9, a mould MD is disposed on the light guide plate sheet 310A as shown.

The mould MD has a generally rectangular parallelepiped shape, and the top and bottom sides of the mould MD (parallel to the light exit surface of the light guide plate sheet 310A) are opened. At least one of four lateral surfaces of the mould MD has a plurality of concave-convex patterns MD1. The concave-convex patterns MD1 may have a ridge-furrow shape. However, the inventive concept is not limited thereto. That is, the concave-convex patterns MD1 may have any other shape suitable for fabrication of light guiding structures.

Referring to FIG. 10, after disposing the mould MD on the light guide plate sheet 310A, a force is applied to the mould MD to cut a light guide plate 310 out of the light guide plate sheet 310A. Since the mould MD includes the concave-convex patterns MD1, a light diffusing pattern 312 is formed on at least one side of the light guide plate 310.

After the light guide plate 310 is fabricated as described above, an optical member (not shown in FIGS. 8 to 10) is disposed on a light exit surface of the light guide plate 310. The optical member may include a diffusing sheet, a prism sheet, and a protective sheet that are sequentially arranged along an optical path of light discharged from the light guide plate 310.

Thereafter, light sources are disposed at predetermined positions so that the light sources can emit light toward the light diffusing pattern 312 of the light guide plate 310. This configuration thus forms prism patterns along the light incident surface of light guide plate 310, so that the above-described light diffusing effect is achieved without cutting and bending a separate prism sheet.

As described above, the inventive concept provides a backlight unit capable of improving image display quality by diffusing light emitted from light sources to a light guide plate.

In addition, the inventive concept provides a method of fabricating the backlight unit.

In addition, the inventive concept provides a display apparatus including the backlight unit.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A backlight unit comprising:
a light guide plate configured to guide light and comprising at least one light incident surface for receiving light, and a light exit surface for directing the received light toward a display panel;
a plurality of light sources configured to emit light toward the light incident surface; and
an optical member comprising at least one sheet disposed at a light exit surface of the light guide plate to direct light output from the light guide plate,
wherein the at least one sheet has a first portion positioned over the light exit surface of the light guide plate, and a second portion positioned over the light incident surface.

2. The backlight unit of claim 1, wherein:
the first portion is a light guide plate cover part covering the light exit surface of the light guide plate; and
the second portion is a light diffusing part bent from at least one side of the light guide plate cover part and disposed between the light guide plate and the light sources.

3. The backlight unit of claim 2, further comprising an adhesive disposed between the light incident surface and the light diffusing part.

4. The backlight unit of claim 2, wherein the sheet is a prism sheet.

5. The backlight unit of claim 4, wherein the prism sheet comprises a plurality of at least approximately parallel prism patterns extending in a direction from one side of the prism sheet to an opposite side of the prism sheet.

6. The backlight unit of claim 5, wherein the prism patterns of the light diffusing part act to diffuse light emitted from the light sources into the light guide plate.

7. The backlight unit of claim 4, further comprising a diffusing sheet disposed between the light guide plate and the light guide plate cover part.

8. The backlight unit of claim 4, further comprising a protective sheet disposed on a light exiting surface of the light guide plate cover part, so as to protect the prism sheet.

9. The backlight unit of claim 2, wherein the sheet is a diffusing sheet.

10. A method of fabricating a backlight unit, the method comprising:
receiving a sheet;
forming at least one bending line in the sheet, the bending line formed in a direction at least approximately parallel with a side of the sheet through a half cutting process, so as to divide the sheet into a light guide plate cover part and a light diffusing part; and
disposing the light guide plate cover part on a light exit surface of a light guide plate and disposing the light diffusing part on a lateral surface of the light guide plate by bending the light diffusing part along the bending line.

11. The method of claim 10, wherein after the forming of the bending line, the method further comprises applying an adhesive to a surface of the light diffusing part for facing the lateral surface of the light guide plate.

12. The method of claim 10, wherein the sheet is a prism sheet.

13. The method of claim 12, wherein the prism sheet comprises a plurality of at least approximately parallel prism patterns extending from one side of the prism sheet to an opposite side of the prism sheet, and wherein the bending line is at least approximately perpendicular to the prism patterns.

14. The method of claim 13, wherein the prism patterns of the light diffusing part act to diffuse light emitted from the light sources into the light guide plate.

15. The method of claim 11, wherein the sheet is a diffusing sheet.

16. A method of fabricating a backlight unit, the method comprising:
preparing a sheet comprising one of polymethylmethacrylate (PMMA) and polycarbonate (PC);
disposing a mold on the sheet, wherein top and bottom sides of the mold are opened and a ridge-furrow shaped pattern is formed on a lateral surface of the mold, the lateral surface extending between the top and bottom sides of the mold;
performing a die-cutting process on the sheet using the mold, so as to form a light guide plate comprising a light diffusing pattern on a light incident surface thereof; and
disposing an optical member at a light exit surface of the light guide plate.

17. A display apparatus comprising:
a backlight unit; and
a display panel,
wherein the backlight unit comprises:
a light guide plate configured to guide light and comprising at least one light incident surface for receiving light, and a light exit surface for directing the received light toward a display panel;
a plurality of light sources configured to emit light toward the light incident surface; and
an optical member disposed at a light exit surface of the light guide plate to direct light output from the light guide plate,
wherein the display panel displays images using light received from the backlight unit,
the optical member comprises at least one sheet, and
the at least one sheet has a first portion positioned over the light exit surface of the light guide plate, and a second portion positioned over the light incident surface.

18. The display apparatus of claim 17, wherein:
the first portion is a light guide plate cover part covering the light exit surface of the light guide plate; and
the second portion is a light diffusing part bent from at least one side of the light guide plate cover part and disposed between the light guide plate and the light sources.

19. The display apparatus of claim 18, wherein the sheet is a prism sheet.

20. The display apparatus of claim 19, wherein the prism sheet comprises a plurality of at least approximately parallel prism patterns extending in a direction from one side of the prism sheet to an opposite side of the prism sheet.

21. The display apparatus of claim 19, further comprising a diffusing sheet disposed between the light guide plate and light guide plate cover part.

22. The display apparatus of claim 18, wherein the sheet is a diffusing sheet.
